(19) United States
(12) Patent Application Publication
(10) Pub. No.: US 2012/0254416 A1
(43) Pub. Date: Oct. 4, 2012

(54) Mainframe Event Correlation

(75) Inventors: Robert Fake, Clifton, VA (US); Deborah Gannaway, Tampa, FL (US)

(73) Assignee: MEAS, LLC, Tampa, FL (US)

(21) Appl. No.: 13/437,636

(22) Filed: Apr. 2, 2012

Related U.S. Application Data
(63) Continuation of application No. 61/470,339, filed on Mar. 31, 2011.

(51) Int. Cl. G06F 15/173

(52) U.S. Cl. 709/224

(57) ABSTRACT

Methods, systems, and devices are described for managing mainframe events based on identified correlation among related events. In the methods, systems, and devices of the present disclosure, a set of events including at least one mainframe event is stored at a data store associated with a mainframe event server module. The set of events is analyzed to identify a correlation among a subset of the stored events according to at least one predefined correlation criterion. A new event is generated based on the identified correlation among the subset of the stored events, and the new event is transmitted to at least one destination Security Information and Event Management (SIEM) application.

### CROSS REFERENCES

The present application claims priority to U.S. Provisional Patent Application No. 61/470,339, entitled “MAINFRAME EVENT CORRELATION,” filed on Mar. 31, 2011, the entire disclosure of which is incorporated herein by reference in its entirety for all purposes. The present application is related to U.S. patent application Ser. No. ______ (Attorney Docket No. P003.01), filed concurrently herewith, entitled “MAINFRAME MANAGEMENT CONSOLE MONITORING,” and U.S. patent application Ser. No. ______ (Attorney Docket No. P004.01), filed concurrently herewith, entitled “MULTIPLE DESTINATIONS FOR MAINFRAME EVENT MONITORING,” each of which is incorporated by reference in its entirety for all purposes.

### BACKGROUND

The present invention relates to mainframe event and message processing in general and, in particular, to the creation and monitoring of records related thereto. Mainframes, in the course of operation, create and monitor a variety of events and other messages (e.g., syslog messages), which contain various information regarding mainframe operations. These records may be analyzed for a variety of purposes. A mainframe may assign specific codes to the event or other messages depending on the triggering circumstance, and also may provide access to the stored records.

The information contained within the mainframe event records may be valuable to third party applications. For example, by analyzing event record codes and event information, third parties may be able to identify various conditions and processing incidents on and recorded by the mainframe. This event record information may disclose a security violation detected on the mainframe system, a mainframe memory issue, an application error, or a variety of other mainframe operations and processing incidents.

In many instances, the high number, variety, and frequency of events recorded on the mainframe make it difficult for third parties to use this information efficiently. Also, the information contained in an event record is in a mainframe specific format (e.g., EBCDIC). Finally, third parties seeking to use event record information are confronted with challenges in interfacing with the mainframe because of the complexity and security.

### SUMMARY

Methods, systems, and devices are described for mainframe event management based on correlations among events.

In a first set of embodiments, a method for managing mainframe events includes storing a set of events including at least one mainframe event at a data store associated with a mainframe event server module, analyzing the set of events to identify a correlation among a subset of the stored events according to at least one predefined correlation criterion, generating a new event based on the identified correlation among the subset of the stored events, and transmitting the new event to at least one destination Security Information and Event Management (SIEM) application.

In a second set of embodiments, a system for managing mainframe events includes a mainframe event server module configured to store a set of events including at least one mainframe event at a data store, and a correlation module configured to analyze the set of events to identify a correlation among a subset of the stored events according to at least one predefined correlation criterion and generating a new event based on the identified correlation among the subset of the stored events. The mainframe event server module is further configured to transmit the new event to at least one destination Security Information and Event Management (SIEM) application.

In a third set of embodiments a system for managing mainframe events includes at least one processor and at least one memory communicatively coupled with the at least one processor. The at least one memory includes executable code that, when executed by the at least one processor, causes the at least one processor to store a set of events including at least one mainframe event at a data store associated with a mainframe event server module, analyze the set of events to identify a correlation among a subset of the stored events according to at least one predefined correlation criterion, generate a new event based on the identified correlation among the subset of the stored events; and transmit the new event to at least one destination Security Information and Event Management (SIEM) application.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a block diagram of an example system including components configured according to various embodiments of the invention.

FIG. 3 is a block diagram of an example mainframe event server module including components configured according to various embodiments of the invention.

FIG. 4 is a block diagram of an example system including components configured according to various embodiments of the invention.

FIG. 5 is a block diagram of an example system including components configured according to various embodiments of the invention.

FIG. 6 is a block diagram of an example correlation module including components configured according to various embodiments of the invention.

FIG. 7 is a block diagram of an example system including components configured according to various embodiments of the invention.

FIG. 8 is a flowchart diagram of an example method of managing mainframe events according to various embodiments of the invention.

FIG. 9 is a flowchart diagram of an example method of managing mainframe events according to various embodiments of the invention.

FIG. 10 is a flowchart diagram of an example method of managing mainframe events according to various embodiments of the invention.

FIG. 11 is a schematic diagram that illustrates a representative payment authority server system that may be used in various embodiments of the present invention.

### DETAILED DESCRIPTION OF THE INVENTION

Methods, systems, and devices are described for monitoring and managing mainframe events. In the methods, systems, and devices of the present disclosure, mainframe events associated with a mainframe are added to a set of events stored at a data store associated with a mainframe event server module. The set of events is analyzed to identify a correlation among a subset of the stored events according to at least one predefined correlation criterion, and a new event is added to the set of events based on the identified correlation among the subset of the events. Each event in the set is transmitted to at least one destination Security Information and Event Management (STEM) application.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of the present disclosure and appended claims, the term “mainframe” refers broadly to a computer system capable of supporting a substantial number (hundreds, thousands, or more) of substantially simultaneous applications and/or users.

For purposes of the present disclosure and appended claims, the term “event” refers broadly to a logged occurrence of an action within an operating system or computer program environment.

For purposes of the present disclosure and appended claims, the term “message” refers broadly to a logged record. A message may be directed to a recipient, or simply a portion of a stored record or log.

For purposes of the present disclosure and appended claims, the term “mainframe console” or “mainframe management console” refers broadly to a command-line interface of a mainframe operating system.

For purposes of the present disclosure and appended claims, the term “Security Information and Event Management (SIEM) application” refers broadly to a computer program configured to provide real-time analysis of security issues in a system based on messages or events received from one or more computer systems in a network. As used herein, the term SIEM application generically refers to both Security Information Management (SIM) applications and Security Event Management (SEM) applications. For purposes of the present disclosure, the terms “SIEM application,” “SIM application,” and “SEM application” are synonymous and interchangeable.

For purposes of the present disclosure and appended claims, the term “mainframe event server module” refers to a hardware implemented module that receives mainframe events associated with a mainframe and distribute those events to one or more third party SIEM applications.

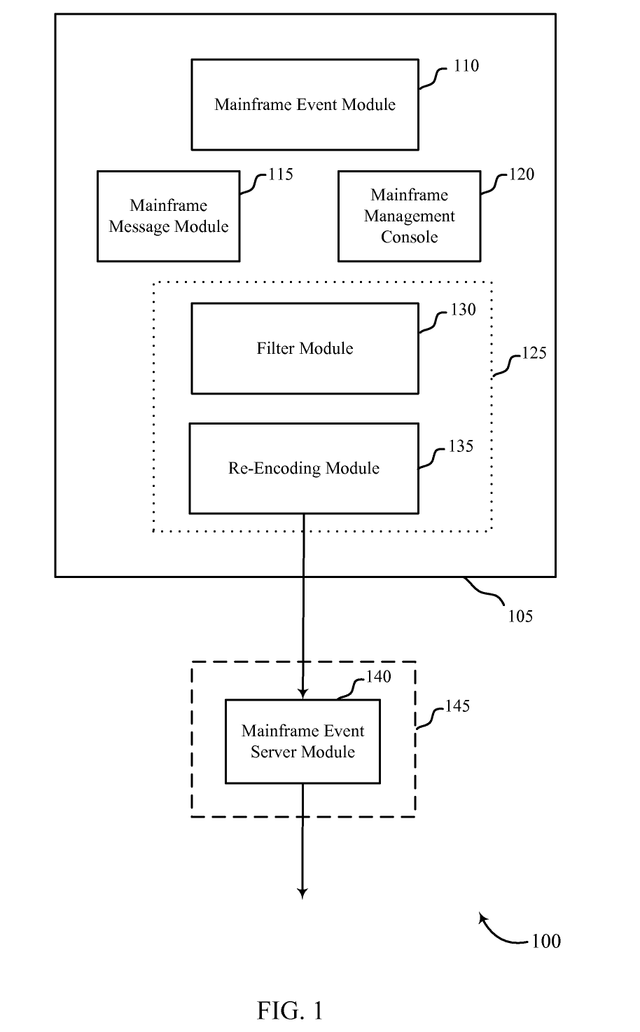

Systems, devices, methods, and software are described for a mainframe event and message processing system 100. In one set of embodiments, shown in FIG. 1, a system 100 includes a mainframe 105 and a mainframe event server module 140. These components may be in communication with each other, directly or indirectly (e.g., via a network). While the illustrated example shows the mainframe event server module 140 residing on server computer system 145 independent from the mainframe 105, in other embodiments the mainframe event server module 140 may be integrated in varying degrees with the mainframe 105.

Components on the mainframe 105 include a mainframe event module 110, a mainframe message module 115, a mainframe management console 120, an event/message filter module 130, and a re-encoding module 135. A mainframe 105 is a high-level system designed for more computationally intensive jobs, and is often utilized by large organizations for managing and executing a variety of complex computer systems and applications. Unlike typical home and business computers, mainframes are designed to handle very high volume input and output with increased computing throughput. Like a typical computer, the mainframe 105 runs an operating system (e.g., IBM's z/OS) that provides functionality including starting and stopping applications, managing memory allocation and access, and reporting a variety of system events.

The mainframe event module 110 may detect, generate, process and/or store events of the mainframe operating system. The events may be system management facility (SMF) events, or be any number of other types of events. The mainframe event module 110 may be integrated in whole or in part with the mainframe 105 operating system, be a separate and distinct control unit on the mainframe 105, or be program or application running on the mainframe 105 operating system. The mainframe event module 110 may process system events reported and forwarded by the operating system and other mainframe systems. The mainframe event module 110 may generate and/or receive the event. During operation, the mainframe 105 operating system may report a variety of mainframe system events indicating various states, actions or system failures, such as a failure to start or complete an action, or a report of unauthorized access of a file on the mainframe 105. These events may be collected by the mainframe event module 110 for storage in an event record database (not specifically shown, although it may be part of mainframe event module 110-a). The mainframe event module 110-a may include a number of sub-modules (e.g., separate sub-modules for system, application, and security), and include a number of different event record databases.

To differentiate the various events reported by the mainframe, unique event codes may be assigned to records of different types mainframe events. Type 80, Type 101 and Type 102 are examples of codes of different “types” of events, and there may be codes for “sub-types” as well. As noted above, in one embodiment the events are SMF events. The SMF events may include DB2, customer information control system (CICS), Resource Access Control Facility (RACF), and other password violation and denied resource access attempt-related events as well as those generated by any application running on the mainframe 105.

As noted, the mainframe event module 110 may include an event record database, or they may be distinct components of the mainframe 105. For example, the mainframe event module 110 may collect events reported by the mainframe and forward the events to a mainframe event record database. The IBM z/OS System Management Facility interface is one example of such a mainframe event module 110.

The mainframe message module 115 may receive, process, generate, and store messages and records related to mainframe events. The mainframe message module 115 may be integrated to varying degrees with the mainframe operating system, be a separate and distinct control unit on the mainframe 105, or be a program or application running on the mainframe 105 operating system. The mainframe message module 115 may process messages reported and forwarded by the mainframe 105 operating system, including the mainframe event module 110, or various programs or applications running thereon or related thereto. During operation, components, programs, or applications associated with the operating system may generate or trigger the generation of a range of informational messages. These messages may be reported to the mainframe message module 115, or may trigger the mainframe message module 115 to generate such messages.

These messages may include, for example, syslog messages directed to a mainframe management console 120. Syslog is an open standard that may be used for system management and security auditing, as well as generalized informational, analysis, and debugging messages. It is supported by a wide variety of devices and programs across multiple platforms. Because of this, syslog may be used to integrate log data from many different types of systems into a central repository, such as the mainframe management console 120.

In additional or alternative examples, these messages may be messages or other information from a database server or manager (e.g., an Information Management System (IMS), or IBM DB2) or a transaction server (e.g., a customer information control system (CICS) or application programs developed or purchased by a customer). The respective servers and sources of information may be on or off the mainframe 105. To differentiate the various messages, unique message codes may be assigned to different types of messages. There may be a variety of formats for different messages (e.g., in one example, the first part of the message code may identify the application, and the second part of the code may identify the message type).

The filter module 130 may directly or indirectly monitor the mainframe event module 110-a and mainframe message module 115 for messages or events matching one or more criteria (e.g., monitoring for identifiers or other types of codes associated with event types or message types). The filter module 130 may be a software process that runs on the mainframe 105. The filter module 130 may copy or otherwise retain message data associated with the specified mainframe event or message types, and route them to the re-encoding module 135. An administrator may specify the types of events and/or messages trapped (e.g., using a web-based graphical user interface (GUI) or input parameters). An administrator may modify the filter criteria dynamically (e.g., without rebooting the mainframe 105). The criteria may change based on the time of day, day of the week, identity of the user, etc.

Thus, in one embodiment, the filter module 130 may monitor the codes of the various event-related messages being transmitted to or from mainframe event module 110-a and/or mainframe message module 115, and copy a relevant subset of messages matching certain criteria to identify a plurality of selected mainframe events. The re-encoding module 135 may receive the events and/or messages from the filter module 130. The re-encoding module 135 may be a software process that runs on the mainframe 105 operating system. The re-encoding module 135 may be from a proprietary mainframe format (e.g., Extended Binary Coded Decimal Information Code (EBCDIC)) into a common machine readable format (e.g., American Standard Code for Information Interchange (ASCII)). Most modern character-encoding schemes are based on ASCII, and proprietary mainframe formats are not commonly used outside of a mainframe environment by non-mainframe systems and third party applications. The re-encoding module 135 may perform other types of re-encoding, as well. In other embodiments, the re-encoding module 135 need not be used (e.g., if a message was already formatted in ASCII). It is worth noting that while the filter module 130 and re-encoding module 135 are depicted as residing as a unit 125 of the mainframe 105, any part of these modules or their functionality may be located off the mainframe (e.g., at server computer system 145).

The re-encoded event or message from re-encoding module 135 may then be forwarded to the mainframe event server module 140. The re-encoding module 135 may group a number of messages for transmission together (e.g., at a user defined interval). The mainframe event server module 140, upon receiving a mainframe event or message, may process the raw, reformatted event or message (e.g., in ASCII), and generate a translated version of that data in open data standard format (e.g., the common event format (CEF)). The mainframe event server module 140 may route and transmit the open data standard format event or message record to any number of different destinations.

The mainframe event server module 140 may also receive information related to correlated events or messages. This correlation may, for example, take place on the mainframe 105, elsewhere on server computer system 145, or on another computer system. Events and/or messages may be correlated based on their proximity in time, and on the process or application which is the subject of the event or message. The mainframe event server module 140 may translate, route, and/or and transmit the correlated events and/or messages to any number of different destinations.

The mainframe event server module 140 may be running on Windows, UNIX, LINUX, or other operating systems. In certain examples, the mainframe event server module 140 may be implemented in Java to allow for greater platform independence. However, other programming languages and platforms may be used in other examples (e.g., Python, Ruby, Scala, or Clojure).

The server computer system 145 hosting the mainframe event server module 140 performing the conversion, routing, and transmission may be fully located within a single facility or distributed geographically, in which case a network may be used to integrate different components. Although the illustrated embodiment shows that a server computer system 145 hosting the mainframe event server module 140 performs the conversion, in other examples these functions may be performed by the mainframe 105 or a virtual server.

Event and message data, in various forms, may be stored in one or more data stores on mainframe 105 and server computer system 145. A data store may be a single database, or may be made up of any number of separate and distinct databases. The data store may include one, or more, relational databases or components of relational databases (e.g., tables), object databases, or components of object databases, spreadsheets, text files, internal software lists, or any other type of data structure suitable for storing data. Thus, it should be appreciated that a data store may each be multiple data storages (of the same or different type), or may share a common data storage with other data stores. In some embodiments the data store may be distinct from the mainframe 105 and the server computer system 145, while in other embodiments it may be integrated therein to varying degrees.

The components of the system 100 may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

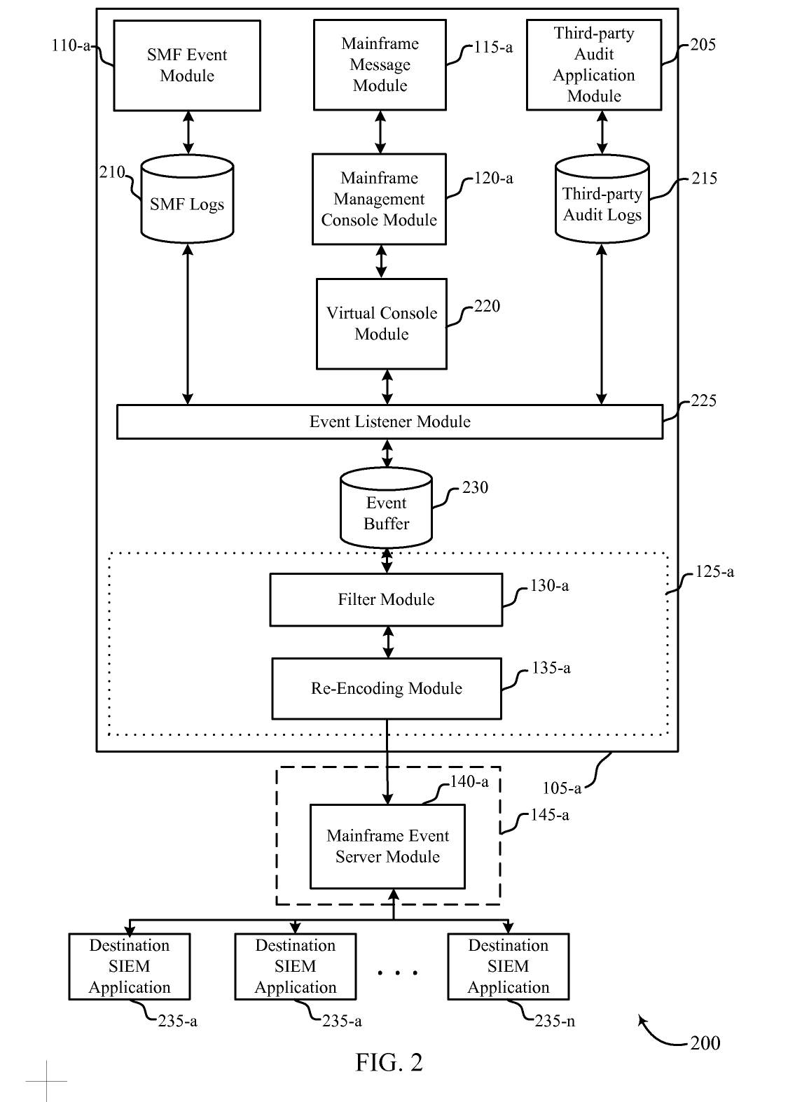

FIG. 2 is a block diagram of another example system 200 for monitoring and management. The system 200 includes a mainframe 105-a, a mainframe event server module 140-a, and a number of destination SIEM applications 235. These components may be in communication with each other, directly or indirectly (e.g., via a network). The system 200 may be an example of the system 100 described above with reference to FIG. 1. While the illustrated example shows the mainframe event server module 140 residing on server computer system 145 independent from the mainframe 105, in other embodiments the mainframe event server module 140 may be integrated in varying degrees with the mainframe 105. One or more of the destination SIEM applications 235 may reside on mainframe 105-a, on the server computer system 145 of the mainframe event server module 140-a, and/or on a separate computer system.

In the present example, the mainframe 105-a includes a mainframe SMF event module 110-a, an SMF log data store 210, a mainframe message module 115-a, a mainframe management console module 120-a, a virtual console module 220, a third-party security audit application module 205, a third-party audit log data store 215, an event listener module 225, an event buffer data store 230, a filter module 130-a, and a re-encoding module 135-a. Each of these components may be in communication, directly or indirectly. The mainframe SMF event module 110-a may be an example of the mainframe event module 110 described above with reference to FIG. 1. Similarly, the mainframe message module 115-a and mainframe management console module 120-a may be examples of the mainframe message module 115 and mainframe management console module 120 described above with reference to FIG. 1. The filter module 130-a and re-encoding module 135-a may be examples of the filter module 130 and re-encoding module 135 described above with reference to FIG. 1.

The mainframe SMF event module 110-a may detect and generate SMF events, which are recorded as log messages in the SMF log data store 210. The mainframe message module 115-a may detect and direct system messages to the mainframe management console module 120-a, which allows an administrator to view the messages. Some or all of these messages may also be mirrored and copied to the virtual console module 220 for use in detecting events without disturbing the flow of the mainframe management console module 120-a.

The third-party security audit application module 205 may monitor and log certain actions and events taken at the mainframe 105-a that are not recorded by the mainframe SMF event module 110-a or the mainframe message module 115-a. In one example, the third-party security audit application module 205 may run a CA TOP SECRET application to monitor the types of security administrative commands issued by a system administrator and other actions that are not monitored by the mainframe SMF event module 110-a or the mainframe management console module 120-a. The TOP SECRET application may be periodically invoked to produce a new audit file on a regular basis, and each audit file may be stored at the third-party audit logs data store 215. Additional or alternatively, any other suitable type of mainframe security audit application may be invoked at the third-party security audit application module 205 to produce audit logs for the third-party audit logs data store 215.

The event listener module 225 may communicate with the SMF logs data store 210, the virtual console module 220, and the third-party audit logs data store 215 to identify mainframe events. These mainframe events may be copied and consolidated in the event buffer data store 230. In certain examples, the event listener module 225 may convert one or more records in the SMF logs data store 210, the virtual console module 220, or the third-party audit logs data store 215 such that all of the events written to the event buffer data store 230 are in the same format. As a large number of mainframe events may occur in a short amount of time, the event buffer data store 230 may have the capability of storing records corresponding to millions of mainframe events or more.

The filter module 130-a may filter the mainframe events in the event buffer data store 230 to select mainframe events according to one or more filtering criteria input by an administrator. The filtering criteria may be as granular or generic as may suit the specifications of a particular administrator or mainframe 105-a. In one example, the filtering criteria may select all events in the event buffer data store 230 having a specific code. Additionally or alternatively, the filtering criteria may select all events in the event buffer data store 230 that begin with or contain a certain string of letters. The filtering criteria may be static, or may be dynamically changed over time. In certain examples, the filtering criteria may be dynamically updated in real-time by an administrator. Additionally or alternatively, the filtering criteria may automatically change based on time of day, mainframe usage, the type or number of applications or clients associated with the mainframe at a given time, and/or any other criteria that may suit a particular application of the principles described in the present disclosure.

The re-encoding module 135-a may convert the events selected by the filter module 130-a from a character encoding scheme associated with the mainframe (e.g., EBCDIC) to a more generic character encoding scheme (e.g., ASCII). In certain examples, the re-encoding module 135-a may perform the first of a series of re-encoding/reformatting steps that are performed on the selected events. For instance, the re-encoding module 135-a may convert the selected events from EBCDIC to ASCII, and the mainframe event server module 140-a may convert all of the selected events to the common event format (CEF). In certain examples, the mainframe event server module 140-a may further convert one or more of the selected events to a format compatible with a destination SIEM application 235. Once the selected events have undergone all appropriate re-encoding and reformatting, the mainframe event server module 140-a may apply a set of rules to select an appropriate destination SIEM application 235 for the selected events and route the selected events to the one or more selected destination SIEM applications 235.

In certain examples, the selected events may be analyzed, and correlations among the selected events may be identified. Based on the identified correlations, new events may be generated. The new events may include warning or notification events deduced from the context of the identified correlations. The new events may be stored in one or more data stores and/or routed to selected destination SIEM applications.

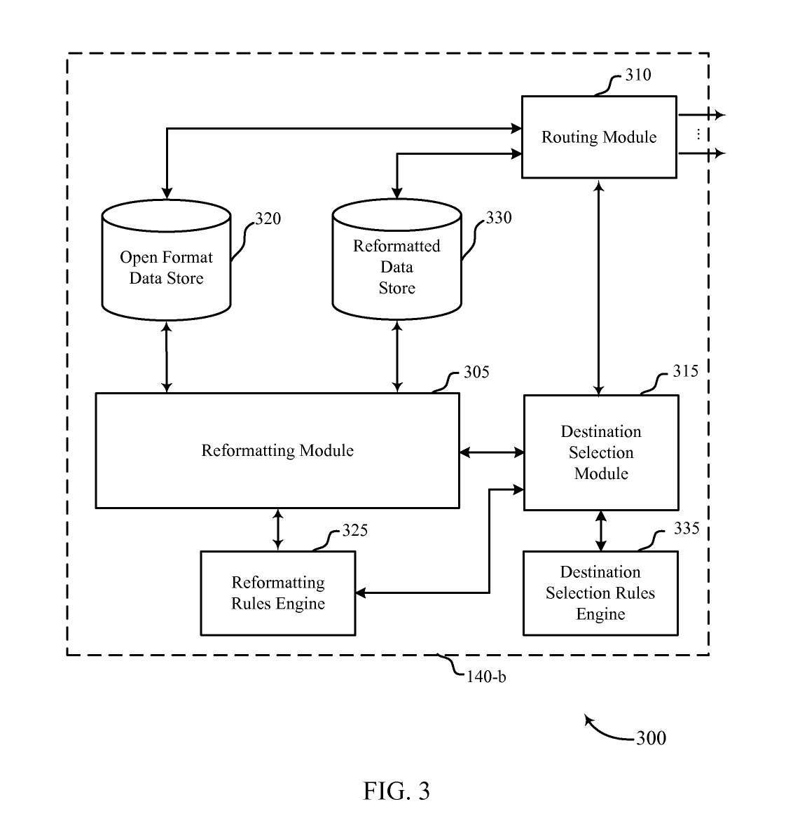

FIG. 3 is a functional block diagram illustrating one example configuration 300 of a mainframe event server module 140-b. The mainframe event server module 140-b of FIG. 3 may be an example of the mainframe event server module 140 of FIG. 1 or FIG. 2. In the present example, the mainframe event server module 140-b includes a reformatting module 305, a routing module 310, a destination selection module 315, an open format data store 320, a reformatting rules engine 325, a reformatted data store 330, and a destination selection rules engine 335. These components may be integrated into a server computer system (e.g., server computer system 145 of FIG. 1 or 2), or portions of the functionality may be located on a mainframe (e.g., mainframe 105 of FIG. 1). This configuration 300 may be implemented using any suitable programming languages (e.g., Java, C, Python, Ruby, Scala, Clojure, etc.) in a variety of platforms (e.g., WINDOWS, UNIX, LINUX).

A mainframe event or message may be received at reformatting module 305 (e.g., from the mainframe 105 of FIG. 1), which may reformat the received raw ASCII data for the mainframe event to an open format (e.g., CEF) and store the event in the open format in the open format data store 320.

The destination selection module 315 may use the destination selection rules engine 335 to determine one or more destinations for the received mainframe event. This selection may be based on administrator preferences, other user input, rules based on the type of event or content of the event, rules based on time of day, rules based on security parameters or profiles, other rules, and/or the like. The destinations may include any number of different SIEM applications (hosted or implemented otherwise). By way of example, such SIEM applications may include SIEM applications from ARCSIGHT, NITROSECURITY, or MCAFEE. In addition, or alternatively, the destination may be an SQL data store.

The destination selection module 315 may further identify a format accepted by the selected destination(s). In certain examples, the format accepted by the selected destination(s) may be the open format to which the event has already been converted. In additional or alternative examples, the format accepted by the selected destination(s) may include one or more proprietary or other formats. If format accepted by the selected destination(s) includes a format that is not the open format, the reformatting module 305 may reformat a copy of the event to the format accepted by the selected destination(s) and store this copy of the event in the reformatted data store 330.

The reformatting rules engine 325 may contain one or more libraries of reformatting rules for use by the reformatting module 305. The reformatting rules may be applied to reformat events to or from an open data standard format (e.g., CEF), a proprietary format associated with a destination SIEM application, and/or a SQL compatible format for storage in a SQL data store.

The routing module 310 may access the reformatted event data, route the data to the applicable destination(s) (e.g., an SQL data store or SIM/SEM application data store), and transmit the appropriately formatted event data accordingly. An event may be transmitted to multiple locations, in the same or different formats. The routing module 310 may be configured to group a set of messages or events for transmission together.

In certain examples, the mainframe event server module 140-b may be configured to receive and process additional events at open format data store 320. These additional events may be generated based on identified correlations among received events that have already been received (e.g., events received from the mainframe). The additional events may, in some examples be written directly to open format data store 320. The additional events may be processed by the reformatting module 305, destination selection module 315, and routing module 310 in the same way as event received directly from the mainframe are processed. In certain examples, the destination selection rules engine 335 may include rules that are specifically applicable to the additional events generated based on the identified correlations. Additionally or alternatively, the additional events generated based on the identified correlations may be subject to the same rules in destination selection as other events.

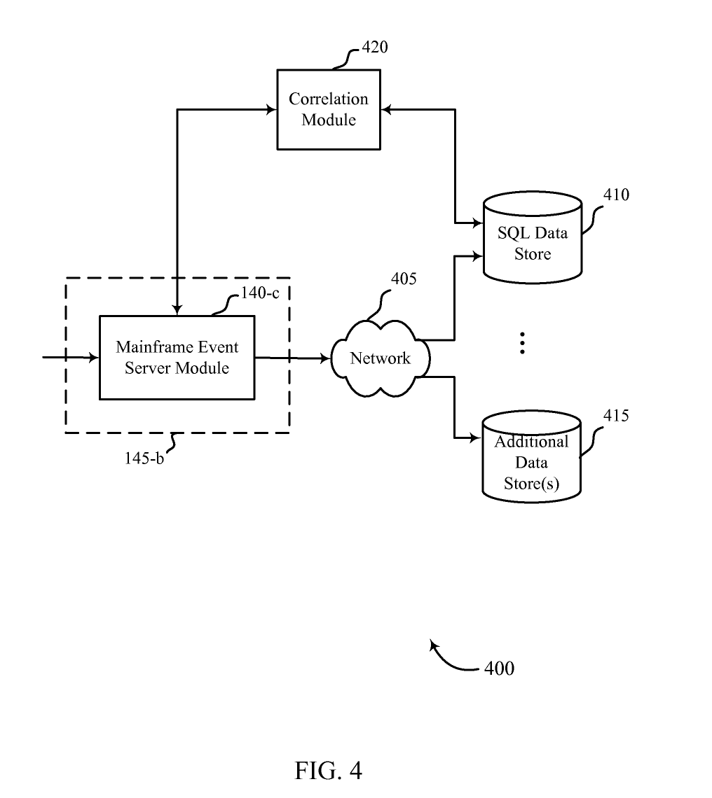

FIG. 4 is a block diagram of a system 400 for event and message processing. It may include a number of aspects of the systems 100, 200 and configuration 300 described with reference to FIG. 1, FIG. 2, or FIG. 3, illustrating examples of mainframe event and message processing system. The system 400 of FIG. 4 includes a mainframe event server module 140-c operating on a server computer system 145-b, a network 405, SQL data store 410, one or more additional data stores 415, and correlation module 420. The mainframe event server module 140-c may receive an event or message from a mainframe (e.g., the raw data from a reformatted event or message in ASCII described with reference to the mainframe 105 of FIG. 1 or FIG. 2). The mainframe event server module 140-c may generate a translated version of that event or message data in open data standard format (e.g., the common event format (CEF)).

The mainframe event server module 140-c may also determine destinations for the data based on user input or other rules. The destinations may include any number of different security information management (SIM) or security event management (SEM) applications (hosted or otherwise), which are hereinafter referred to collectively as SIEM applications. By way of example, such SIEM applications may include applications from ARCSIGHT, NITROSECURITY, and MCAFEE. The mainframe event server module 140-c may reformat the event or message in open data standard format (e.g., CEF) into a proprietary format associated with one or more selected destination SIEM applications. The reformatted event/message data may be routed to one of the additional data stores 415 associated with the selected SIEM application(s). In addition, or alternatively, the selected destination(s) may include the SQL data store 410. In certain examples, the mainframe event server module 140-c may reformat the event or message from the open data standard format (e.g., CEF) into a format for storage at SQL data store 410.

Thus, the mainframe event server module 140-c may receive a mainframe event or message in ASCII, and may translate that data to an open data standard format. The mainframe event server module 140-c may determine a destination for the event or message (e.g., the SQL data store 410, a third-party SIEM application, and/or additional data store 415 associated with a third-party SIEM application). If the destination needs to receive data in a certain format, the mainframe event server module 140-c may reformat the data (e.g., into a format associated with the SQL data store 410, the third-party STEM application, or one of the other data stores 415). In some examples, the destination may use the open data standard format, in which case the data may be forwarded in the open data standard format.

In one example, a correlation module 420 analyzes events and/or messages stored in the SQL data store 410, and performs correlations. Events and/or messages may be correlated based on their proximity in time, and the relation between the processes or applications which are the subject of the event or message. By way of example, certain security-related events occurring at the same time, or a threshold number of security violation events occurring within a threshold amount of time, may signal a heightened security risk (e.g., indicating that a hacker is attempting to access information, or a virus is spreading). In other examples, a set of events indicating that a user has been granted access to a protected resource and revoked access to that resource within a threshold amount of time may signal a heightened security risk (e.g., indicating that a user is surreptitiously manipulating a system to gain access to a protected resource for which that user is not authorized).

The correlation module 420 may report the correlation to the mainframe event server module 140-c, and this information may be in the form of a brief summary or longer report. The correlated events and messages may be appended to the report. In one example, the correlation report is generated as a new event. The correlation report may trigger a number of security related actions by the mainframe event server module 140-c. For example, the mainframe event server module 140-c may translate, route, and/or transmit the correlation report and correlated events and/or messages to any number of different destinations (e.g., the SQL data store 410 or additional data stores 415). The destinations may include different security information and event management (STEM) applications (hosted or otherwise).

The correlation module 420 may be a stand alone computer system in local or remote communication with SQL data store 410 and server computer system 145-b. Alternatively, the correlation module 420 may be integrated in varying degrees with the SQL data store 410, server computer system 145-b, or a mainframe (e.g., mainframe 105 of FIG. 1 or FIG. 2).

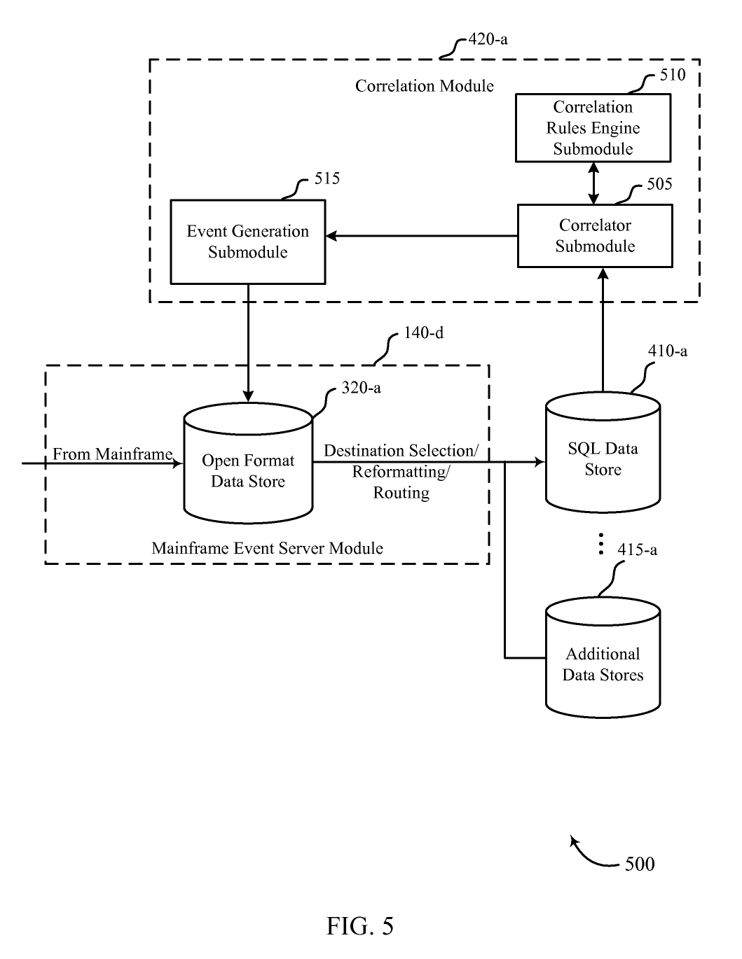

FIG. 5 is a functional block diagram illustrating embodiments of an event and message correlation system 500. This may, but need not be, an implementation of the correlation functionality described with reference to FIG. 1, FIG. 2, FIG. 3, or FIG. 4. The system 500 of the present example includes correlation module 420-a, mainframe event server module 140-d, SQL data store 410-a, and additional data stores 415-a. Each of these components may be in communication, directly or indirectly. These components may be integrated into one or more server computer systems (e.g., server computer system 145 of FIG. 1 or FIG. 2). The correlation module 420-a and data stores 410-a, 415-a may be examples of the correlation module 420 and data stores 410, 415 described above with reference to FIG. 4. The mainframe event server module 140-d may be an example of the mainframe event server module 140 described above with reference to FIG. 1, FIG. 2, or FIG. 3.

The SQL data store 210-a may store mainframe events and/or messages. These may be the events and messages received and reformatted by the mainframe event server module 140-d. In one example, they are trapped mainframe events or messages reformatted by mainframe event server module 140-d from CEF into an SQL-compatible format.

The correlation module 420-a monitors the SQL data store 410-a for correlations among the various events and messages. As noted, the correlation module 420-a includes a correlator submodule 505, a correlation rules engine submodule 510, and an event generation submodule 515. There may be a set of correlation rules in correlation rules engine submodule 510, identifying criteria for correlator submodule 505 to use in analyzing events and messages in SQL data store 410-a. The correlator submodule 505 may analyze trapped events or messages as or after they are stored in the SQL data store 410-a. If the trapped events and messages trigger one or more correlation rules, the correlator submodule 505 may identify a correlation and initiate the event generation submodule 515 to create one or more new events (or otherwise generate a correlation report).

The event generation submodule 515 may populate the new event(s) with data from the correlated events and messages. The event generation submodule 515 may format the new event in an open data standard format (e.g., CEF). The event generation submodule 515 may store the new event(s) in the open format data store 320-a associated with the mainframe event server module 140-d (e.g., with other events and messages formatted in CEF). The open format data store 320-a may store trapped mainframe events and messages in CEF. Both the new event and the older events and messages in the open format data store 320-a may be translated, routed, and/or and transmitted to any number of different destinations (e.g., the additional data stores 215 of FIG. 2 and/or the SQL data store 410-a). In certain examples, the same process and selection criteria are used to route both the newer events and older events and messages to destinations. The destinations may include different security information and event management (SIEM) applications (hosted or otherwise) and/or another type of store.

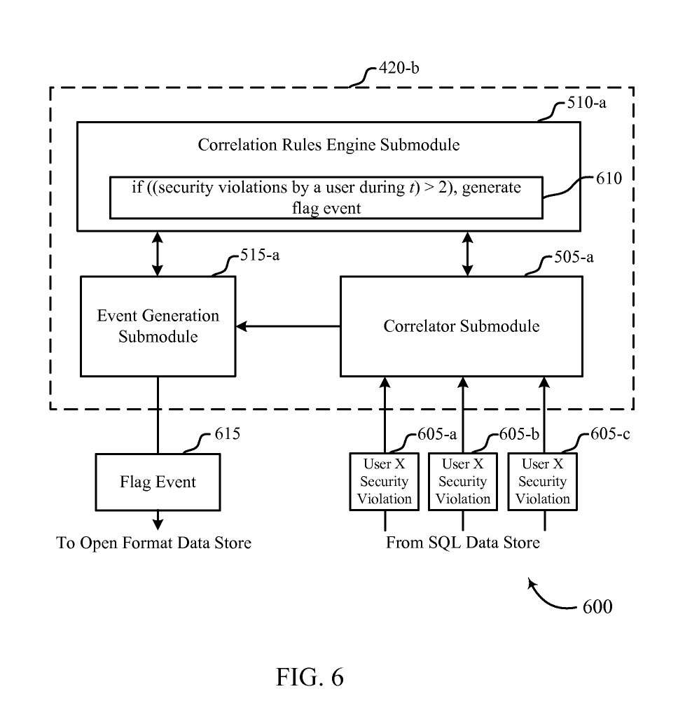

FIG. 6 is a block diagram of an example of a system 600 of event correlation. The system 600 of FIG. 6 illustrates an example of a correlation module 420-b communicating with a SQL data store (e.g., SQL data store 410 of FIG. 4 or FIG. 5) and an open format data store (e.g., open format data store 320 of FIG. 3 or FIG. 5) to generate and distribute new events based on detected correlations among events received from a mainframe and/or other sources. The correlation module 420-b may be implemented on the same server system implementing a mainframe event server module (e.g., mainframe event server module 140 of FIG. 1, FIG. 2, FIG. 3, FIG. 4, or FIG. 5) and/or other devices. The system 600 of FIG. 6 may be an example of aspects of the system 100 described in FIG. 1, the system 200 described in FIG. 2, the configuration 300 described in FIG. 3, the system 400 described in FIG. 4, or the system 500 described in FIG. 5.

In the example of FIG. 6, a correlator submodule 505-a communicates with a SQL data store (e.g., SQL data store 410 of FIG. 4 or FIG. 5) that stores a number of mainframe events. The correlator submodule 505-a may query the SQL data store for events matching predetermined correlation criteria and receive a response from the SQL data store indicative of the events stored by the SQL data store that match the predetermined correlation criteria. In the present example, a correlation rule 610 stored at a correlation rules engine submodule 510-a may indicate that a flag event is to be generated if more than two security violation events for the same user are dated within a threshold period of time. Thus, the correlator submodule 505-a may query the SQL data store for all security violation events matching the correlation criteria. This query may be performed on an individual user basis, or a general query may be made for any events stored at the SQL data store which implicate the correlation rule 610.

In response to the request made by the correlator submodule 505-a, the SQL data store may return representations of three events 605 stored by the SQL data store which implicate the correlation rule 610. As shown in FIG. 6, each event 605 returned by the SQL data store may be a security violation event for user X. Additionally, each of the events 605 returned by the SQL data store may have been logged within the threshold period of time. Consequently, the correlation rule 610 dictates that a flag event 615 is to be generated based on the security violation events 605 received from the SQL data store.

The event generation submodule 515-a, upon determining that the correlation rule 610 has been implicated by the security violation events 605, may generate the flag event 615 and populate the flag event 615 with information derived from at least the subject security violation events 605. Additionally, the event generation submodule 515-a may add information to the flag event 615 relating to the implicated correlation rule 610, the date/time the flag event, and/or any other data that may suit a particular application of these principles. The flag event 615 may be generated in an open format, such as the Common Event Format (CEF). The flag event 615 may be forwarded to the open format data store (e.g., open format data store 320 of FIG. 3 or FIG. 5) of the mainframe event server module (e.g., mainframe event server module 140 of FIG. 1, FIG. 2, FIG. 3, FIG. 4, or FIG. 5) for routing to a destination SIEM application or data store in communication with a selected destination SIEM application.

In certain examples, the flag event 615 may be written to the same SQL data store that stores the mainframe events from which the flag event 615 was derived. By storing the flag event 615 and other correlation-based events with the original mainframe events in the same data store, additional new events may be generated based on correlations among events at different levels of abstraction. For example, a correlation between the flag event 615 and another mainframe event stored at the SQL data store may trigger a new event for storage in the SQL data store and delivery to a specified SIEM destination.

While the example of FIG. 6 is given in the context of a single correlation rule 610 for clarity in explanation, it should be understood that the correlation module 420-b may store and enforce any number of correlation rules that may suit a particular application of the principles of this disclosure. Moreover, any number of correlation criteria may be stored and used to identify correlations among the events stored by the SQL data store which implicate the correlation rules.

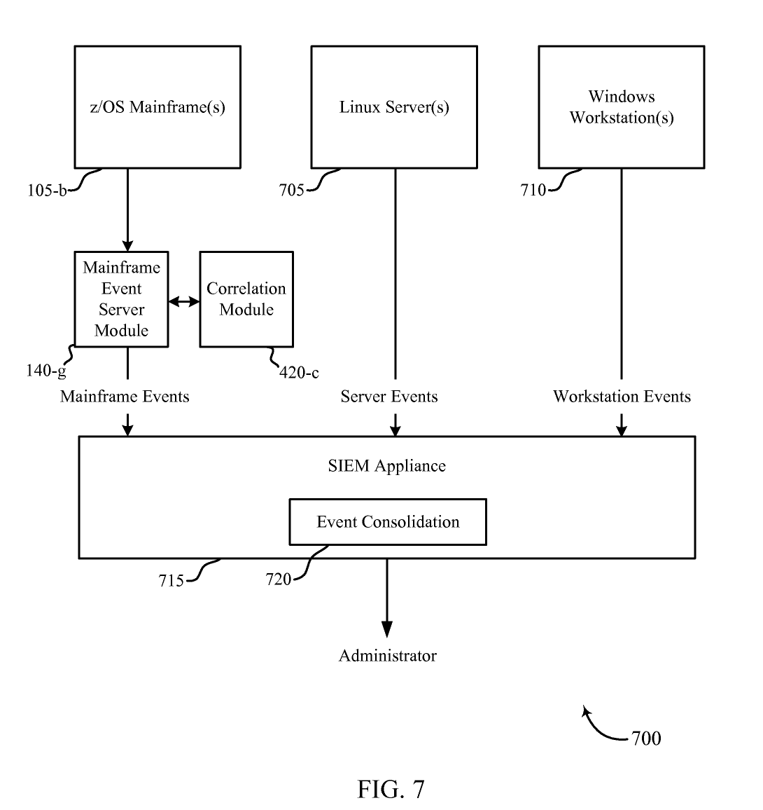

FIG. 7 is a functional block diagram illustrating one example of a system 700 including one or more z/OS mainframes 105-b, one or more Linux servers 705, and one or more Windows workstations 710. The mainframe(s) may be an example of the mainframe 105 described above with reference to FIG. 1 or FIG. 2. In the present example, the mainframe(s) 105-b, the server(s) 705, and the workstation(s) 710 are each able to output events to a single SIEM appliance 715. The SIEM appliance 715 may include a computing device running one or more SIEM applications (e.g., SIEM applications 235 of FIG. 2 or FIGS. 5A-5D). In certain examples, the SIEM appliance may be implemented by one or more of the mainframe(s) 105-b, server(s) 705, or workstation(s) 710.

In past systems, an SIEM appliance 715 used to view events from servers 705 and workstations 710 may not have been able to also view z/OS mainframe events. However, the mainframe(s) 105-b of the present example may be associated with a filter module (e.g., filter module 130 of FIG. 1 or FIG. 2) which monitors the mainframe management console and other sources of data to trap mainframe events of interest, a re-encoding module (e.g., re-encoding module 135 of FIG. 1 or FIG. 2) that re-encodes the trapped mainframe events of interest, a mainframe event server module 140-g that selectively reformats and routes the trapped mainframe events to one or more destination SIEM applications, and a correlation module 420-c which analyzes the trapped mainframe events for correlations and generates new events based on identified correlations. Collectively, these modules may work together as described above to provide SIEM appliance 715 with access to mainframe events of interest, including mainframe events generated directly by the mainframe 105-b and events generated by the correlation module 420-c based on correlations between mainframe events. In this way, the SIEM appliance 715 may consolidate events of interest received from mainframe and non-mainframe sources at event consolidation module 720 and provide a unified view of the events to an administrator or other user.

Furthermore, by incorporating mainframe events into a SIEM appliance 715 that tracks server and workstation events, additional troubleshooting and deductive diagnostic capabilities may be introduced. For example, a set of rules may be applied to a combination of events of different types and from different sources to provide a more adequate and granular view of system health.

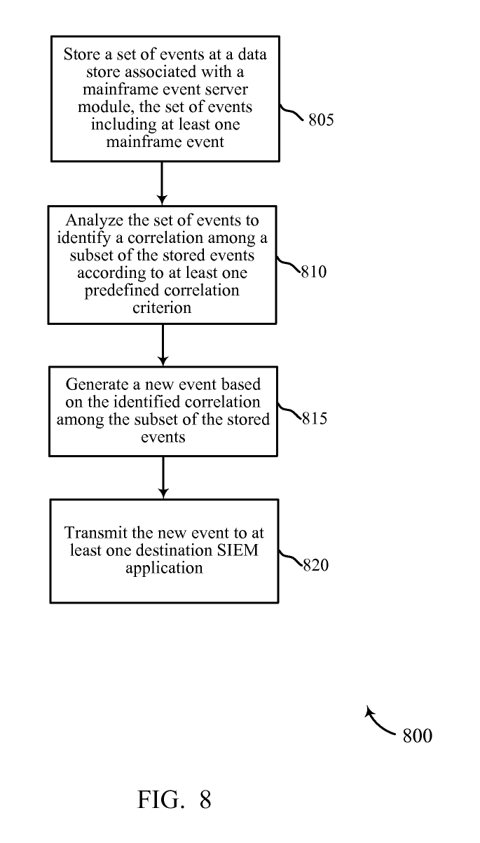

Referring next to FIG. 8, a flow chart is shown illustrating an example method 800 for monitoring and managing mainframe events. This method 800 may, for example, be performed in whole or in part by the mainframe event server module 140 of FIG. 1, FIG. 2, FIG. 3, FIGS. 5A-5D, FIG. 6, or FIG. 7; the correlation module 420 of FIG. 4, FIG. 5, FIG. 6, or FIG. 7; and/or the data stores 410, 415 of FIG. 4 or FIG. 5. As described above, the mainframe event server module 140 and the correlation module 420 may be implemented in whole or in part by mainframe 105 of FIG. 1, FIG. 2, or FIG. 7, and/or by a separate computing device in communication with the mainframe.

At block 805, a set of events including at least one mainframe events is stored at a data store associated with a mainframe event server module (e.g., mainframe event server module 140 of FIG. 1, FIG. 2, FIG. 3, FIG. 4, FIG. 5, FIG. 6, or FIG. 7). The set of events may include a number of trapped raw mainframe events that are filtered, copied, and re-encoded prior to receipt by the mainframe event server module. In certain examples, the mainframe event server module may receive the mainframe events in a format specific to the mainframe and reformat the received mainframe events to an open format (e.g., CEF) prior to storing the mainframe events in the data store. In certain examples, the data store may be a SQL or similar data store. Alternatively, the data store may include any other type of data store that may suit a particular application of the principles described herein. The mainframe event server may perform additional reformatting to make the mainframe events suitable for storage in the data store.

At block 810, the set of events is analyzed to identify a correlation among a subset of the stored events according to at least one predefined correlation criterion, and at block 815 a new event based on identified correlation is generated. The at least one predefined correlation criterion may specify a type of correlation among events that triggers a certain rule. For instance, a predefined correlation criterion may include a threshold number of event types and a threshold period of time, such that if the threshold number of events of the specified type occur within the threshold period of time, an action is triggered. Thus, a predefined correlation criterion may specify a minimum number of security violation events occurring within a specified period of time, such that a correlation rule will cause a security flag event to be generated if the minimum number of security violation events occurs within the specified period of time.

In another example, a predefined correlation criterion may define an event type associated with granting access to a resource, an event type associated with revoking access to the resource, and a threshold period of time. In this example, if an administrative user attempts to surreptitiously grant himself access to a protected resource on a mainframe, makes an unauthorized change to the protected resource, and then quickly revokes his access to the protected resource to cover his tracks, a correlation between the mainframe events associated with granting and revoking access to the protected resource may be determined This identified correlation may trigger the generation of a security flag or other warning event.

In still other examples, a predefined correlation criterion may define different types of events that, when substantially concurrent, may indicate an availability of processing resources (e.g., CPU cycles, memory, I/O devices, etc.) at the mainframe. Thus, the predefined correlation criterion may identify a certain concurrent event types that indicate a dangerously low availability of system resources. When a subset of concurrent events of these types are identified, a correlation rule may trigger the generation of a flag or other warning event.

In certain examples, the set of events stored at the data store is analyzed at block 810 by submitting a query to the data store based on the at least one predefined correlation criterion. In these examples, the subset of correlated stored events may be identified in a response to the query from the data store.

At block 820, a format associated with the selected destination SIEM application is identified. In certain examples, the format identified for the SIEM application may be the open format. In other examples, the format associated with the selected destination SIEM application may be a proprietary format. Where the format associated with the selected destination SIEM application is a something other than the open format, the at least one mainframe event may be converted at the mainframe event server module from the open format to the identified format associated with the selected SIEM application.

At block 820, the new event is transmitted to a selected destination SIEM application. The destination SIEM application may be selected based on a set of rules. In certain examples, the destination SIEM application may be selected from a plurality of available SIEM applications. The destination SIEM application may be implemented in whole or in part at the mainframe and/or at a computing device in direct or indirect communication with the mainframe. In certain examples, a content and/or type of the at least one mainframe event is determined, and the destination SIEM application is selected based at least on the content or type of the at least one mainframe event. Additionally or alternatively, other rules may be used to select the destination SIEM application, including rules based on time of day, security parameters and profiles, administrator preferences, SIEM application load, and the like.

In certain examples, the transmission of the new event to the selected destination SIEM application includes writing the new event to a text file associated with the selected destination SIEM application (e.g., in a folder on a server to which the destination SIEM application has access). Additionally or alternatively, the transmission includes writing the new event to a syslog daemon associated with the selected destination SIEM application. In additional or alternatively examples, the transmission may include writing the at least one mainframe event to a data store (e.g., the data store containing the set of stored events or another data store) associated with the selected destination SIEM application. The new event may be converted to a format accepted by the selected destination SIEM application prior to transmission.

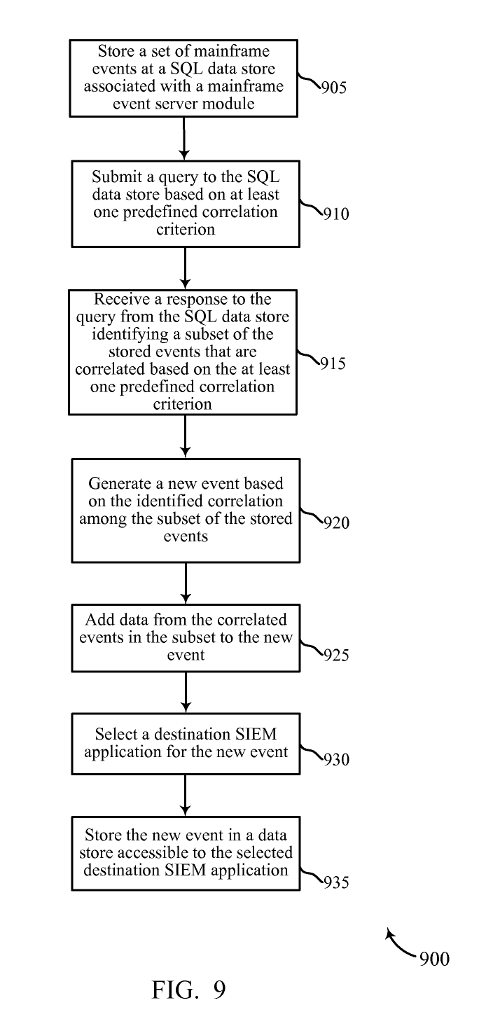

Referring next to FIG. 9, a flow chart is shown illustrating another example method 900 for monitoring and managing mainframe events. This method 900 may, for example, be performed in whole or in part the mainframe event server module 140 of FIG. 1, FIG. 2, FIG. 3, FIGS. 5A-5D, FIG. 6, or FIG. 7; the correlation module 420 of FIG. 4, FIG. 5, FIG. 6, or FIG. 7; and/or the data stores 410, 415 of FIG. 4 or FIG. 5. As described above, the mainframe event server module 140 and the correlation module 420 may be implemented in whole or in part by mainframe 105 of FIG. 1, FIG. 2, or FIG. 7, and/or by a separate computing device in communication with the mainframe. The method 900 of FIG. 9 may be an example of the method 800 of FIG. 8.

At block 905, a set of mainframe events is stored at a SQL data store associated with a mainframe event server module (e.g., mainframe event server module 140 of FIG. 1, FIG. 2, FIG. 3, FIG. 4, FIG. 5, FIG. 6, or FIG. 7). At block 910, a query is submitted to the SQL data store based on at least one predefined correlation criterion to analyze the set of stored events and identify a correlation among a subset of the stored events. At block 915, a response to the query is received from the SQL data store which identifies the subset of the stored events that are correlated based on the at least one predefined correlation criterion.

At block 920, a new event is generated based on the identified correlation among the subset of the stored events. At block 925, data from or based on the correlated events in the subset is added to the new event. At block 930, a destination SIEM application is selected for the new event based on a set of rules. At block 935, the new event is transmitted to the selected destination SIEM application by storing the new event in a data store accessible to the selected destination SIEM application.

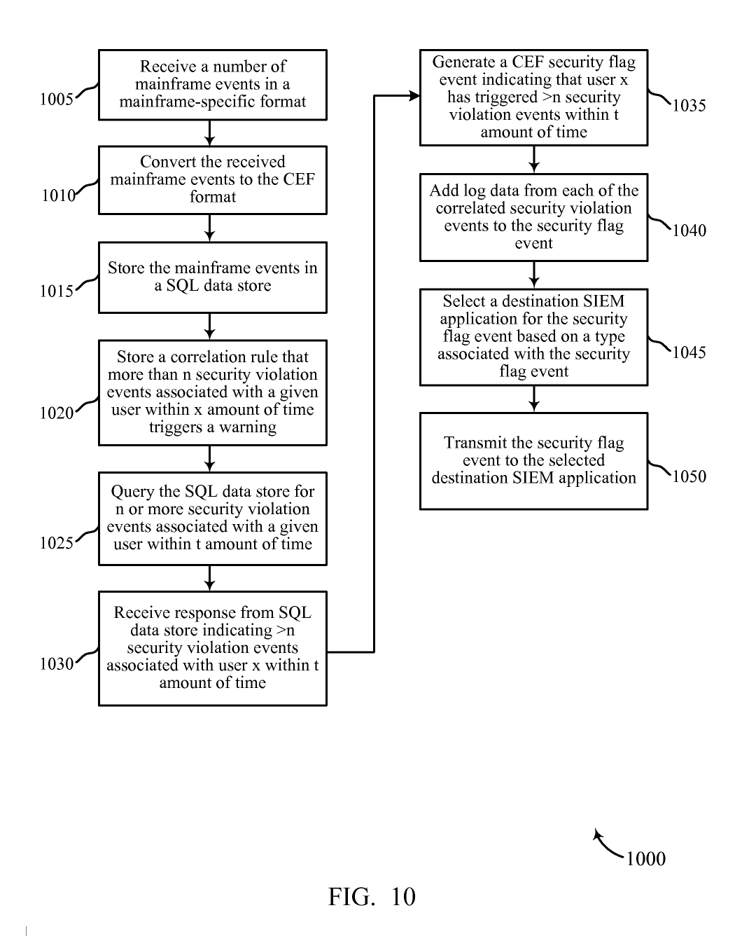

Referring next to FIG. 10, a flow chart is shown illustrating another example method 1000 for monitoring and managing mainframe events. This method may, for example, be performed in whole or in part by the mainframe event server module 140 of FIG. 1, FIG. 2, FIG. 3, FIG. 4, FIG. 5, FIG. 6, or FIG. 7; the correlation module 420 of FIG. 4, FIG. 5, FIG. 6, or FIG. 7; and/or the data stores 410, 415 of FIG. 4 or FIG. 5. As described above, the mainframe event server module 140 and the correlation module 420 may be implemented in whole or in part by mainframe 105 of FIG. 1, FIG. 2, or FIG. 7, and/or by a separate computing device in communication with the mainframe. The method 1000 of FIG. 10 may be an example of the method 800 of FIG. 8 or the method 900 of FIG. 9.

At block 1005, a number of mainframe events is received at a mainframe event server module in a raw mainframe-specific format. At block 1010, the received mainframe events are converted to an open format (e.g., CEF). At bock 1015, the mainframe events are stored in a SQL data store associated with the mainframe event server module. At block 1020, a correlation rule that more than n security violation events associated with a given user with t amount of time triggers a warning event. At block 1025, the SQL data store is queried for n or more security violation events associated with a given user within t amount of time. At block 1030, a response from the SQL data store is received, the response indicating more than n security violation events associated with user x within t amount of time.

At block 1035, a CEF security flag event is generated based on the correlation between the security violation events in the data store response, the security flag event indicating that user x has triggered more than n security violation events within t amount of time. At block 1040, log data from each of the identified security violations associated with user x is added to the new security flag event. At block 1045, a destination SIEM application is selected for the security flag event based on a type associated with the security flag event. At block 1050, the security flag event is transmitted to the selected destination SIEM application, where an administrator may receive the security flag event and take remedial action, if necessary.

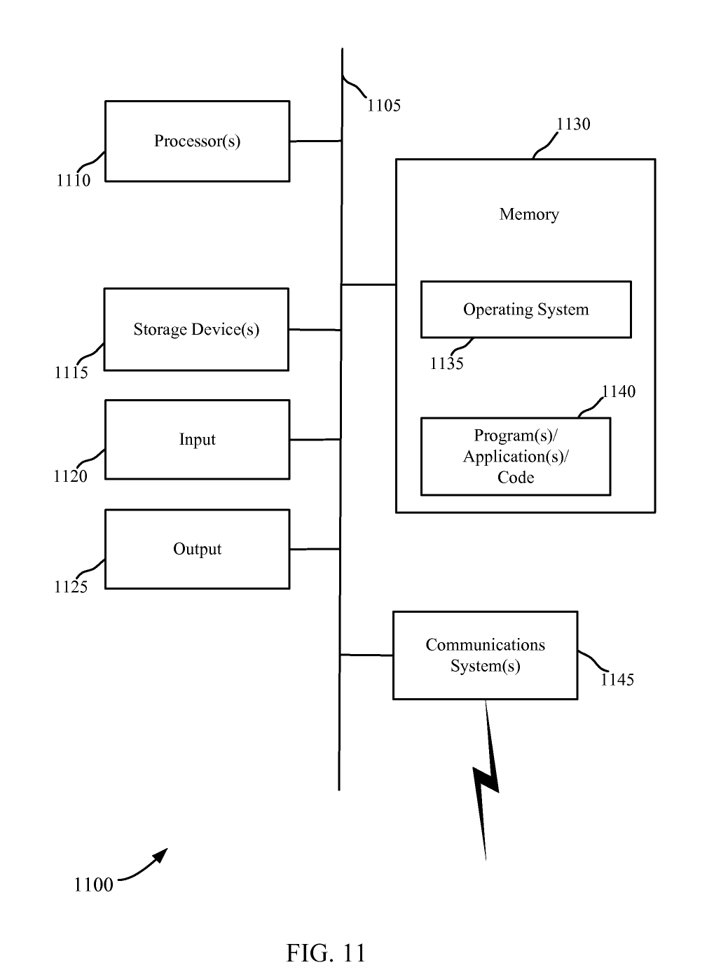

A device structure 1100 that may be used for a mainframe 105 of FIG. 1 or 2; for the mainframe event server module 140 of FIG. 1, FIG. 2, FIG. 4, FIG. 5, FIG. 6, or FIG. 7; for the correlation module 420 of FIG. 4, FIG. 5, FIG. 6, or FIG. 7, for a computer device or SIEM appliance 715 implementing one or more of the destination SIEM applications 235 of FIG. 2, FIGS. 5A-5D, or FIG. 7; or for other computing devices or modules described herein, is illustrated with the schematic diagram of FIG. 11. This drawing broadly illustrates how individual system elements of each of the aforementioned devices may be implemented, whether in a separated or more integrated manner. The exemplary structure is shown comprised of hardware elements that are electrically coupled via bus 1105, including processor(s) 1110 (which may further comprise a DSP or special-purpose processor), storage device(s) 1115, input device(s) 1120, and output device(s) 1125. The storage device(s) 1115 may be a machine-readable storage media reader connected to any machine-readable storage medium, the combination comprehensively representing remote, local, fixed, or removable storage devices or storage media for temporarily or more permanently containing computer-readable information. The communications systems 1145 may interface to a wired, wireless, or other type of interfacing connection that permits data to be exchanged with other devices. The communications system(s) 1145 may permit data to be exchanged with a network.

The structure 1100 may also include additional software elements, shown as being currently located within working memory 1130, including an operating system 1135 and other code 1140, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for managing mainframe events, comprising:
storing a set of events at a data store associated with a mainframe event server module, the set of events comprising at least one mainframe event;
analyzing the set of events to identify a correlation among a subset of the stored events according to at least one predefined correlation criterion;
generating a new event based on the identified correlation among the subset of the stored events; and
transmitting the new event to at least one destination Security Information and Event Management (SIEM) application.

2. The method of claim 1, wherein the analyzing the set of events comprises:
submitting a query based on the at least one predefined correlation criterion to the data store.

3. The method of claim 2, wherein the identifying the correlation among the subset of the stored events comprises:
receiving a response to the query from the data store, the response identifying the subset of stored events.

4. The method of claim 1, wherein:
the at least one predefined correlation criterion comprises a threshold number of events of a specified type and a threshold amount of time; and
the analyzing the set of events to identify the correlation among the subset of the events comprises determining that the subset of the stored events contains the threshold number of events of the specified type occurring within the threshold amount of time.

5. The method of claim 1, wherein the analyzing the set of stored events to identify the correlation among the subset of the stored events comprises:
identifying a first event in the subset associated with granting access to a resource;
identifying a second event in the subset associated with revoking access to the resource, the first event and the second event occurring within the threshold amount of time.

6. The method of claim 1, wherein the analyzing the set of stored events to identify the correlation among the subset of the stored events comprises:
identifying a correlation associated with resource availability at the mainframe among the subset of the stored events.

7. The method of claim 1, further comprising:
receiving the at least one mainframe event at the mainframe event server module in a format specific to the mainframe; and
converting the at least one mainframe event to an open format prior to adding the at least one mainframe event to the set of stored events.

8. The method of claim 7, wherein the open format comprises Common Event Format (CEF).

9. The method of claim 1, further comprising:
selecting the at least one destination STEM application based on at least one of a type of the new event or a content of the new event.

10. A system for managing mainframe events, comprising:
a mainframe event server module configured to store a set of events at a data store, the set of events comprising at least one mainframe event; and
a correlation module configured to analyze the set of events to identify a correlation among a subset of the stored events according to at least one predefined correlation criterion and generate a new event based on the identified correlation;
wherein the mainframe event server module is further configured to transmit the new event to at least one destination Security Information and Event Management (SIEM) application.

11. The system of claim 10, wherein the correlation module is further configured to:
submit a query based on the at least one predefined correlation criterion to the data store.

12. The system of claim 11, wherein the correlation module is further configured to:
receive a response to the query from the data store, the response identifying the subset of stored events.

13. The system of claim 10, wherein:
the at least one predefined correlation criterion comprises a threshold number of events of a specified type and a threshold amount of time; and
the correlation module is further configured to analyze the set of events to identify the correlation among the subset of the events by determining that the subset of the stored events contains the threshold number of events of the specified type occurring within the threshold amount of time.

14. The system of claim 10, wherein the correlation module is further configured to analyze the set of events to identify the correlation among the subset of the events by:
identifying a correlation associated with resource availability at the mainframe among the subset of the stored events.

15. The system of claim 10, wherein the mainframe event server module is further configured to:
receive the at least one mainframe event in a format specific to the mainframe; and
convert the at least one mainframe event to an open format prior to adding the at least one mainframe event to the set of stored events.

16. The system of claim 15, wherein the open format comprises Common Event Format (CEF).

17. A system for managing mainframe events, the system comprising:
at least one processor;
at least one memory communicatively coupled with the at least one processor, the at least one memory comprising executable code that, when executed by the at least one processor, causes the at least one processor to:
store a set of events at a data store associated with a mainframe event server module, the set of events comprising at least one mainframe event;
analyze the set of events to identify a correlation among a subset of the stored events according to at least one predefined correlation criterion;
generate a new event based on the identified correlation among the subset of the stored events; and
transmit the new event to at least one destination Security Information and Event Management (SIEM) application.

18. The system of claim 17, wherein the executable code further causes the at least one processor to:
submit a query based on the at least one predefined correlation criterion to the data store.

19. The system of claim 17, wherein the executable code further causes the at least one processor to:
receive a response to the query from the data store, the response identifying the subset of stored events.

20. The system of claim 17, wherein:
the at least one predefined correlation criterion comprises a threshold number of events of a specified type and a threshold amount of time; and
the executable code further causes the at least one processor to determine that the subset of the stored events contains the threshold number of events of the specified type occurring within the threshold amount of time.
